(19) United States
(12) Patent Application Publication
(10) Pub. No.: US 2023/0265586 A1
(43) Pub. Date: Aug. 24, 2023

(54) FABRIC WITH WOVEN INTEGRATED LIGHTING

(71) Applicant: Aspen Valley Christmas LLC, Evanston, IL (US)

(72) Inventors: Robert BOHLIN, Evanston, IL (US); Yu chi TSAI, Tsuen Wan (HK)

(21) Appl. No.: 17/678,131

(22) Filed: Feb. 23, 2022

(51) Int. Cl. D03D 15/547; A47G 33/08; F21V 8/00

(52) U.S. Cl. CPC D03D 15/547; A47G 33/08; G02B 6/001; A47G 2033/0827; D10B 2503/00

(57) ABSTRACT

A woven textile has one or more weavable threads and at least one lighting filament in which the weavable threads and the at least one lighting filament are woven together to form a textile with integrally woven lighting.

### FIELD OF THE INVENTION

The present invention relates to a woven textile and in particular a textile having woven threads and lighting filament forming a woven integrated illuminated textile.

### BACKGROUND OF THE INVENTION

Consumers have the need of decorative materials such as bows, ribbons, table top coverings including table runners, table skirts and tree skirts may be formed from various textile materials. These materials include woven materials such as ones formed from polyester, cotton, silk, wool, and the like.

Recently, consumers have requested these materials to include the addition of lighting to create illuminated ribbons, bows, tree skirts, and table runners with integrated lights to decorate their homes. Using the existing products in the market, consumers can place light strands adjacent to, for examples on top of or underneath, the fabric. The wires from those light strands are exposed and can be easily damaged. For example, in some prior instances, a strip of lights is affixed to the material for example a strip of lighting added to a ribbon which may be tied to form a bow. Traditionally, the lighting is glued or otherwise affixed to the exterior surface of a previously formed sheet material such as a ribbon.

### SUMMARY OF THE INVENTION

The present invention relates to a unique woven material in which individual threads are woven with one or more lighting filaments to produce an integral woven textile. The textile with integrally woven lighting may form a ribbon and the ribbon may be subsequently shaped to create a bow. Other products can be formed from the textile with integrally woven lighting includes but are not limited to wreathes, table top surface treatment including table runners and tree skirts. The textile can have any shape including square, circle, oval, elongated, etc.

While the textile with integrally woven lighting is well suited for seasonal decor, the woven textile can be used for other decorative purposes. The lighting for the textile advantageously is in the form of a lighting filament (woven within the textile) and may be composed of light emitting diodes (LEDs), i.e., an LED strand, a series of incandescent lights and/or a fiber optic line/cable/wire operatively associated with an illuminating source providing light to the fiber optic line/cable/wire.

The present invention in one form thereof is directed to a woven textile which has one or more weavable threads and at least one lighting filament. The weavable threads and the at least one lighting filament are woven together to form a textile with integrally woven lighting. In various alternative forms, the lighting filament comprises an LED strand, a strand of incandescent lights or a fiber optic line/cable/wire. As appropriate, the integrally woven lighting textile may have a power source to provide electricity to the lighting filament such as a battery or AC transformer or a source of light to illuminate the lighting filament when the lighting is composed of a fiber optic filament/line/cable/wire.

The present invention in another form thereof is directed to a method of manufacturing a textile with integrally woven lighting. The method includes weaving at least one lighting filament with a one or more weavable threads to form a textile with integrally woven lighting.

Advantages of having the lighting woven with the body of the textile itself allows the lighting to be visible on both sides or faces (front and back) of the textile. Further, integrating the lighting within the textile means that wires or fiber optic lines/wires are concealed within the textile itself and not prominently visible on the surface of the textile itself.

It will also be apparent that the present textile with integrated lighting can be incorporated into various usage including safety equipment and clothing, pet collars and vests, wedding decorations and accessories, including but not limited to lighted bridal bouquets and associated ribbons, etc. The fabric or textile with integrated lighting can be incorporated into curtains or drapes. Further one can create light shows by programming lighting patterns for the integrated lighting of the textile/fabric material with integrated lighting.

### BRIEF DESCRIPTION OF THE DRAWINGS

The present invention will now be described with reference to the drawings as follows.

FIG. 1 is a schematic diagram of a textile with integrally woven lighting in accordance with the present invention.

FIG. 2 is an enlargement of area A of FIG. 1.

FIG. 3 is a schematic of a weaving machine for producing a textile with integrally woven lighting in accordance with the present invention.

FIG. 4 is an enlargement of area B of FIG. 3.

FIG. 5 is a flowchart showing a manufacturing process in accordance with the present invention.

FIG. 6 is a ribbon formed from the textile with integrally woven lighting from FIG. 1.

FIG. 7 is a bow formed from the ribbon of FIG. 6.

### DETAILED DESCRIPTION

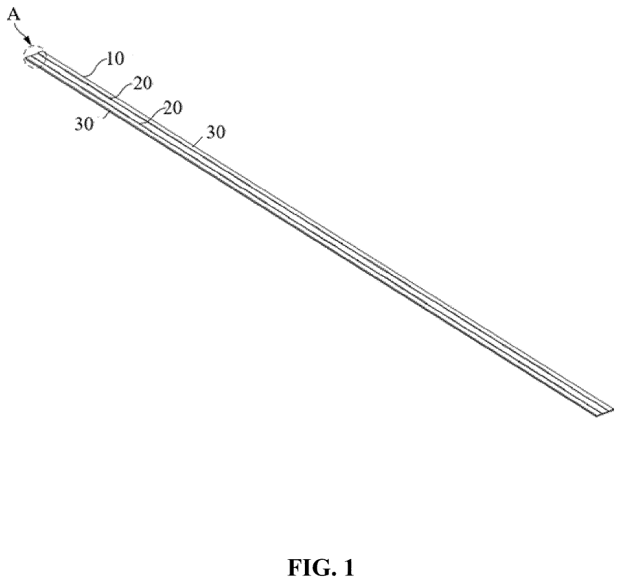

The present invention will now be described with regard to the FIGS. 1-7 and with reference to the following elements shown in the various figures.

### LEGENDS FOR THE FIGURES

10 woven fabric material (e.g. ribbon)
12 weavable fibers
20 light strand
21 LED light
22 light cord
30 metal wire
40 weaver
41 first turntable
42 second turntable
43 weaving mechanism
44 third turntable
45 wire passage board
46 wire passage hole
47 first through hole
48 second through hole
49 adjusting mechanism

A textile with integrally woven lighting is produced by using conventional weaving techniques in which individual weavable threads of fabric are woven with one or more lighting filaments, such as strands of lighting material, to form a woven textile with integrally woven lighting.

The following disclosure describes various embodiments, forms and designs produced using various weaving techniques. However, multiple additional weaving techniques and woven products integrally woven lighting can be produced. Accordingly, the following examples or exemplar products provide an understanding of the present textile with integrally woven lighting.

Used throughout this disclosure, when one element is referred to as being “affixed” with another element, the former can be directly on or within the latter; when one element is referred to be “connected” to another element, the former can be directly connected to or within the latter. The terms “vertical”, “horizontal”, “left”, “right”, etc., used herein are for illustrative purposes only.

Unless otherwise defined, all technical and scientific terms used herein have the consensus meanings understood by those skilled in the technical field of the current invention. The terms used in this disclosure are only for the purpose of describing specific examples, and are not intended to set limits for the claimed invention. As used herein, the term “and/or” includes any and all combinations of one or more related listed items.

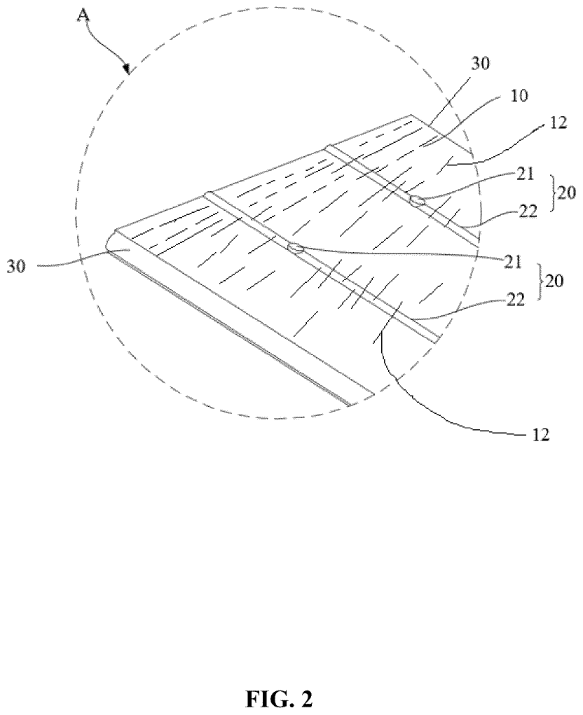

FIGS. 1 and 2 are directed to an exemplary textile with integrally woven lighting forming a fabric material such as fabric ribbon 10 with integrally woven lighting. The ribbon 10 can be directly hung as an ornament. Alternatively, ribbon 10 can be folded (or tied) into various forms such as a bow or a Chinese ornamental knot to generate custom ornaments. While ribbon 10 is an elongated shaped material, the fabric material can have any shape, including but not limited to square, circle, oval, etc.

The ribbon 10 is formed from a woven fabric that is made by weaving weavable fibers or thread with at least one light strand 20. The woven fabric ribbon 10 contains a number of weaving threads 12. The threads 12 are composed of cotton. However, as desired, the threads can be other materials such as yarn, hemp, nylon, and other synthetic blends.

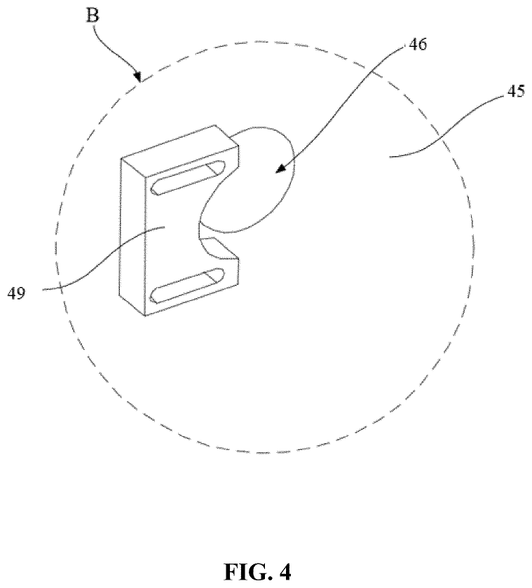

Specifically, the woven fabric ribbon 10 is manufactured by weaving a number of weaving threads 12 through manual or machine weaving (e.g. weaver 40 in FIG. 4). The light strand 20 consists of multiple LED lights 21 and light cords 22 used to connect the LED lights 21 in series with pre-arranged intervals along the length of the woven fabric ribbon 10. The light cords 22 are contained within and affixed between a number of the weaving threads.

Ribbon 10 can be folded or tied into various ornaments as desired or hung directly for decoration purposes because the ribbon 10 is pliable or flexible. The light strands 20 can be used as lighting. In addition, the light strands 20 allow the ribbon 10 to play a decorative role at night, thus enhancing the decorative function of this embodiment. Because the light strand 20 is affixed between several weaving threads 12, the light strand 20 is integrally formed with and secured within the woven material (i.e. threads 12) of the ribbon 10. Even when folded, the light strand 20 remains secure in place within the woven fabric ribbon 10.

Furthermore, because the light strands 20 are woven between several weaving threads 12, light can be emitted from within ribbon 10 to the exterior of the weave of ribbon 10. The light strand 20 is not easily damaged because it embed within the woven fabric of ribbon 10.

It should be noted that the number of light strands 20 is adjustable depending on illumination design or effects desired. For example, there can be one, two, or other numbers of light strands 20. When there are multiple light strands 20, the light strands 20 are preferably arranged in parallel. Nonetheless, in some models, multiple light strands 20 may also be crisscrossed.

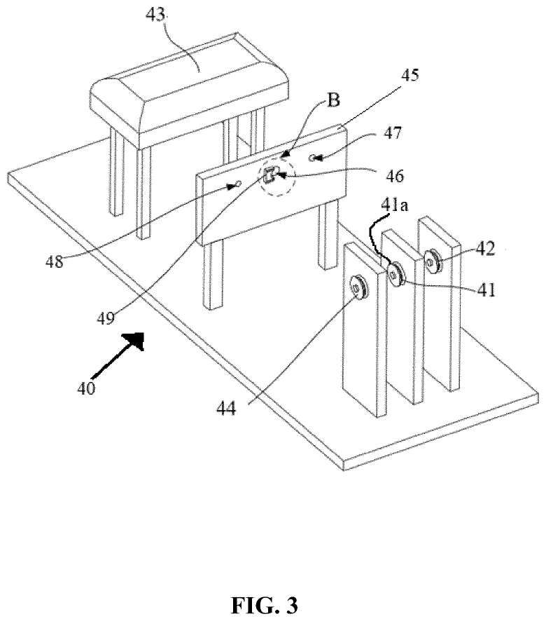

The light cord 22 is woven with at least one of the weaving threads (e.g. threads 41a (FIG. 3)), so that the light cord 22 and at least one of the weaving threads are intertwined or interwoven. Specifically, the light cord 22 and the weaving thread can be woven together manually or by machine. By weaving the light cord 22 and the weaving thread (41a) together, the light cord 22 can be stably secured in place.

It should be noted that there are various methods to weave the light cord 22 and the weaving thread (41a (FIG. 3)) together. An example of one technique using a weaver will be discussed below with regard to FIG. 3.

The light cord 22 as the center, one or more weaving threads 41a can be woven around the light cord 22. Alternatively, a light cord 22 can also be woven together with one or more weaving threads in a manner like a multi-strand braid.

In a different alternative form, multiple weaving threads are woven to form a through hole to accommodate the light cord 22. Through holes extend along the length of the woven fabric ribbon 10. The light strand 20 is inserted into the through hole. It should be noted that, in this embodiment of a ribbon with integrally woven lighting, the light strand 20 can be inserted into the through hole after the through hole is completely formed or simultaneously when the through hole is in the process of being woven.

The ribbon with integrally woven lighting, in this embodiment, since the light strand 20 is inserted in the through hole, the light strand 20 can be detached for maintenance or replacement.

When the weaving thread is made advantageously cotton, the weaving process is simplified as will be more apparent from the discussion of the weaver of FIG. 3.

In alternative forms, the weaving threads can be made of one or more of the following materials: silk, cotton, yarn, hemp, nylon, and other synthetic blends.

It should be noted that other weave thread (material) can be metal such as iron wire or copper wire. For example, ribbon 10 may have at least one metal wire 30 that is accommodated and affixed between multiple weaving threads. The metal wire 30 can maintain its shape after being bent. Thus, the metal wire 30 allows the ribbon 10 to be folded and maintained in a desired shape easily.

The extension direction of metal wire 30 is the same as the extension direction of the woven fabric ribbon 10. It may be advantages to have a pair of metal wires 30, one located on either edge of ribbon 10. However, the specific number of the metal wires 30 is not limited, and multiple other numbers of metal wires 30 can also be used.

The metal wire 30 can be woven with at least one of the weaving threads (41a), so that metal wire 30 and at least one of the weaving threads (41a) are intertwined. Specifically, metal wire 30 and the weaving thread (41a) can be woven together manually or by machine. By weaving the light metal wire and the weaving thread (41a) together, the metal wire 30 can be stably secured in place.

It should be noted that there are various methods to weave the metal wire 30 and the weaving thread together. The metal wire 30 as the center, one or more weaving thread can be woven around the metal wire 30. Alternatively, a metal wire 30 can also be woven together with one or more weaving threads in a manner like a multi-strand braid.

In various specific forms or embodiments, metal wire 30 is an iron wire or an iron wire plated with an anti-rust coating. Because the iron wires are pliable and relatively hard, consumers can fold the product easily. In addition, the anti-rust finish makes metal wire 30 in this embodiment rust resistant. It should be noted that in additional models, metal wire 30 can also be an aluminum wire, a copper wire, a silver wire, or the like.

The ribbon 10 can be produced using various known weaving techniques in the art. They include the following manufacturing process steps:
Prepare a weaving thread and a light strand 20. The light strand 20 includes multiple LED lights 21 arranged in series with specific intervals along a light cord 22.
The lamp cord 22 and the weaving thread (41a) are woven together to form a starlight fabric ribbon according to pre-designed inputs.
The production process for ribbon 10 combines the weaving thread (41a) and the light strand 20 through weaving, resulting ribbon 10 with LED lights integrated into the weave of the fabric. The light strand 20 is securely placed within weave of ribbon 10. Ribbon 10 can function during the day or night.

Alternatively, other manufacturing methods may be used to produce the a ribbon in the form of a textile with integrally woven lighting which include the following general steps:
Prepare a weaving thread, a light strand 20, and a metal wire 30. The light strand 20 includes multiple LED lights 21 arranged in series with specific intervals along a light cord 22. The metal wire 30 is pliable and can maintain the shape after being bent.
The light cord 22, the weaving thread, and the metal wire 30 are woven together according to pre-designed inputs.
The production process for the ribbon combines the weaving thread, the metal wire 30, and the light strand 20 through weaving, resulting in fabric ribbons with LED lights and metal wires integrated into the fabric.
The light strand 20 and the metal wire 30 are securely placed within the starlight fabric ribbon. The ribbon produced by the process can function during the day or at night.
In addition, because the metal wire 30 is pliable and can maintain the shape after being bent, the ribbon produced using the process can be conveniently folded into different shapes desired for decorating.

Various adaptations can be made to the general processes described above which include the following additional steps:
A ribbon with integrally woven lighting can be cut into a predetermined length. Through this step, the ribbon can be easily stored and organized; and the consumers can obtain ribbon of desired length.
Power on the cut fabric ribbon with integrally woven lighting is achieved by powering on the ribbon resulting in the light strands 20 to emit light, enhancing the appearance of the ribbon.

Furthermore, the starlight fabric ribbon can be processed using following the step:
The starlight fabric ribbon is bent to form a desired shape.
Specifically, through this step, the starlight fabric ribbon can be folded into a beautiful shape such as a bow or a Chinese ornamental knot.
In addition, the starlight fabric ribbon can be folded into other shapes.

Referring now to specifically to FIGS. 3 and 4, one specific machine and manufacturing technique for producing ribbon 10 is weaver 40. The Weaving 40 includes a first turntable 41, the second turntable 42, and a weaving mechanism 43. A weaving thread 41a is wound on the first turntable 41 and a light strand 20 is wound on the second turntable 42. The weaving mechanism 43 weaves the weaving thread 41a from first turntable 41 with the light strand 20 from second turntable 42 to form the ribbon 10 (FIGS. 1 and 2). The weaver 40 can automatically weave the weaving thread 41a and the light strand 20 together, which improves the production efficiency. It should be noted that the weaving principle of the weaving mechanism 43 is similar to the spinning principle of the existing weaving equipment, and will not be repeated here.

Weaving 40 further includes a third turntable 44 on which a metal wire 30 is wound. The weaving mechanism 43 can weave the weaving thread 41a (from first turntable 41) together with the metal wire 30 (from third turntable 44).

Weaver 40 can automatically weave the metal wire 30, weaving thread 41a, and the light strand 20 together. Ribbon 10 produced by the weaving can be easily processed further and folded by consumers.

It should be noted that the weaving thread 41a, light strand 20, and metal wire 30 can be used to create any of the textiles with integrally woven lighting, including but not limited to the specific examples of ribbons, bows, table runners, tree skirts, etc. Accordingly, the method for making the various textiles with integrally woven lighting will not be repeated.

In order to prevent the weaving thread, light strand 20, and metal wire 30 from being tangled during the conveying process, weaving 40 includes a wire passage board 45. A wire passage hole 46 is for the light strand 20. In addition, the wire passage board 45 has a first through hole 47 for weaving thread 41a and a second through hole 48 for the metal wire 30. The light strand is constrained by the wire passage hole 46; the weaving thread is constrained by the first through hole 47; and the metal wire 30 is constrained by the second through hole 48. Thus, the weaving thread 41a, light strand 20, and metal wire will not be tangled during the conveying process, allowing for stable production.

A movable adjustment mechanism 49 is provide wire passage board 45. The adjustment mechanism 49 can be moved towards the wire passage hole 46 to partially block the wire passage hole 46, and thereby, adjust the opening of the wire passage hole 46. The size of the wire passage hole 46 can thus to be modified to accommodate different types of light strands 20.

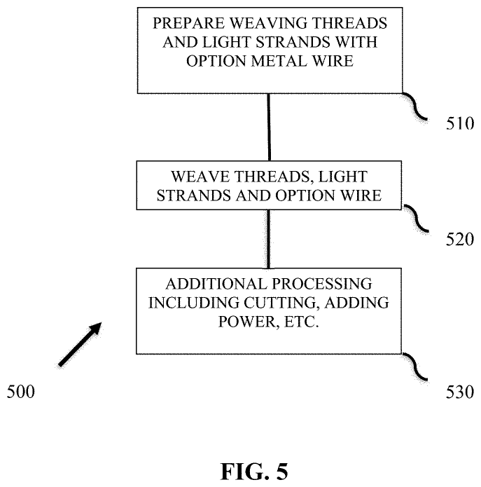

Referring now to the flowchart of FIG. 5, in general, method 500 for producing the present ribbon with woven integrated lighting (e.g. ribbon 10) comprises preparing one or more weaving threads, e.g. thread 41a, i.e., a plurality of weavable threads and one or more lighting filaments. (Step 510). The threads (41a) are woven together to form a woven textile in which the weavable threads and the one or more lighting filaments are woven together to form an integrated integral material. (Step 520). The woven textile can be in the form of narrow strips such as ribbon 10 (FIG. 1). (Step 520). Alternatively, wider textiles can be formed such as would form a runner for a table or a skirt of a table or tree such as a Christmas tree. Further, the ribbon can be tied to form a bow as desired.

Finally, additional processing of the woven textile with lighting from Step 520 can be processed which include cutting it to a specific length, attaching a batter or AC connector or fiber optic light source as desired. (Step 530).

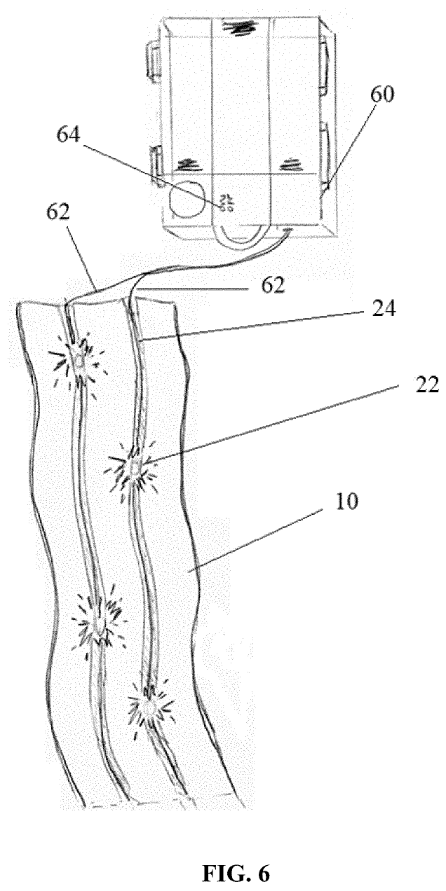

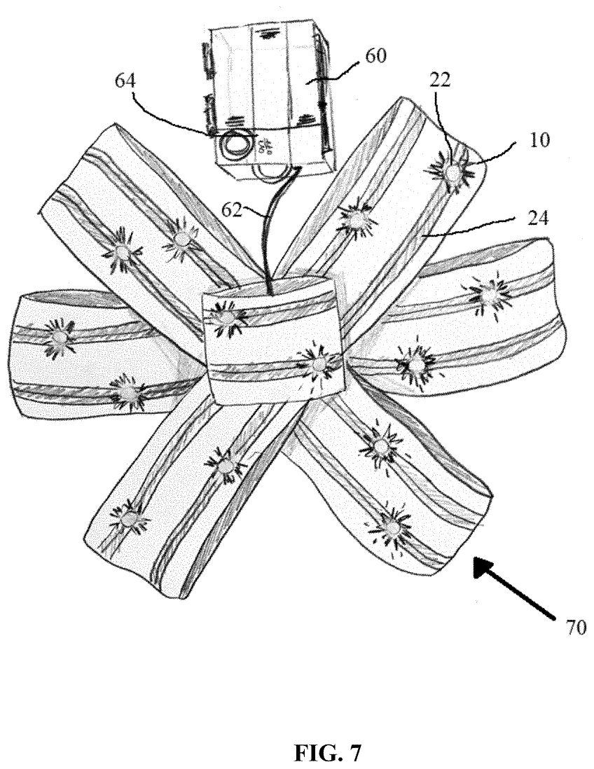

Referring now to FIGS. 6 and 7, power to illuminate ribbon 10 can be power supple 60 joined to light strands 20 via wires 62. FIG. 6 shows ribbon 10 with power supply 60 and FIG. 7 shows the ribbon 10 of FIG. 6 formed into bow 70.

Power supply 60 include batteries (not shown) providing DC power to light strands 20. The light cord 22 is electrically connected to the batteries through switch 64. Thus, ribbon 10 has its own power source for the LED lights 21, allowing usage away from any walled power supplies. There is no need for additional power cords to use ribbon 10.

The battery housing of power supply 60 includes a box for installing batteries, a connecting rod (not shown) bonded on the box exterior, and a buckle on one end of the connecting rod (not shown), and a notch (not shown) on the box exterior of power supply 60. The battery housing can be closed by snapping the buckle into the notch. This way, the starlight fabric ribbon can be clamped between the connecting rod and the box through the engagement of the buckle and the notch; and the battery housing can be easily positioned anywhere along ribbon 10.

In other forms, an inverter (not shown) can be located between the battery box (power supply 60) and ribbon 10. When connected to the light strand (22), the inverter can convert the direct current output (DC) by the battery into alternating current (AC). Through the inverter, the LED lights 21 can be lit according to prearranged programs, adding an additional function to the ribbon 10.

As desired, a remote control and a remote control switch on the light cord 22 can provide wireless control over power supplied to ribbon 10. In an alternative form, rather use of power supply 60, the ribbon 10 can instead be connected to an external power source such as a household power source or a mobile power source (e.g., a power bank).

Accordingly ribbon 10 can be powered on in two ways, as in the following two models:
Battery operated: Connect the battery housing to the ribbon. Install batteries in the battery housing. The batteries are then electrically connected to the light cord 22. By installing batteries, the ribbon can have its own power supply and can emit light. This allows using the ribbon in places away from walled power sources, avoids additional wires, and adds convenience to consumers.
AC operated: Connect the starlight fabric ribbon with an external power source such as a household AC power source or a mobile power source (e.g., a power bank).

In one specific alternative form, rather than an electrical light strand, a fiber optic wire, cord, or line is woven with thread(s) 41a and a light source (not shown) is operatively associated with the fiber optic wire to provide illumination. The light source can be powered by any suitable power supply include power supply 60 which provides DC power to the light source that in turn provides illumination to the fiber optic line of the textile with integrally woven lighting.

It will now be clear to those skilled in the art that the present textile with woven integrated lighting offers advantages and benefits not found in prior materials in which lights are affixed to various materials. The present production process is entirely different than prior techniques of attaching light strand(s) on fabric. In contrast, the present manufacturing process creates a completely unique product (i.e. woven textile) that integrates the light strand(s) (e.g. LED lights) within the fabric, itself, and thereby reducing damages to the lights from forces and environmental factors outside of the fabric, and offers consumers the ease and convenience of not having to manually attach lights to the exterior of the fabric.

The above-mentioned textile with integrally woven lighting and manufacturing methods and techniques models are representative and a non-exhaustive list. The descriptions provided are specific and detailed, but should not be interpreted as a limitation on the range of technical specifications. Please note that those with standard technical skills in the field may make various modifications and improvements based on the models presented in the current invention. These modifications and improvements all fall within the protection scope of the current invention. Therefore, the protection scope of the patent of the current invention should be subject to the appended claims.

It will also be apparent that the present textile with integrated lighting can be incorporated into various usage including safety equipment and clothing, pet collars and vests, wedding decorations and accessories, including but not limited to lighted bridal bouquets and associated ribbons, etc. The fabric or textile with integrated lighting can be incorporated into curtains or drapes.

Further one can create light shows by programming lighting patterns for the integrated lighting of the textile/fabric material with integrated lighting. For example a computer processor can be associate with the lighting to create lighting patterns for the textile.

Further, although the invention has been described above in relation to preferred embodiments thereof, it will be understood by those skilled in the art that variations and modifications can be accomplished in these preferred embodiments without departing from the scope and spirit of the invention.

1. A woven textile comprising:
one or more weavable threads,
at least one lighting filament,
said plurality of weavable threads and at least one lighting filament woven together to form a textile with integrally woven lighting.

2. The woven textile of claim 1, wherein the lighting filament comprises an light emitting diode (LED) strand.

3. The woven textile of claim 2, wherein the LED strand comprises a plurality of individual LEDs.

4. The woven textile of claim 1, wherein the lighting filament comprises a strand of incandescent lights.

5. The woven textile of claim 1, further comprising a power source to power the lighting filament.

6. The woven textile of claim 5, wherein the power source is selected from the group consisting of a battery or an A/C transform.

7. The woven textile of claim 1, wherein the lighting filament comprises a fiber optic filament.

8. The woven textile of claim 7, further comprising a light source operationally associated with the fiber optic filament to provide illumination to the fiber optic filament.

9. The woven textile of claim 1, wherein the textile forms a ribbon.

10. The woven textile of claim 9, wherein the ribbon is formed into a shape of a bow.

11. The woven textile of claim 1, wherein the woven textile forms a table runner.

12. The woven textile of claim 1, wherein the woven textile forms a tree skirt.

13. The woven textile of claim 1, wherein the plurality of weavable threads are selected from the group consisting of polyester, cotton, nylon, silk, wool and combinations thereof.

14. The woven textile of claim 1, further comprising a metal wire joined to the woven textile.

15. The woven textile of claim 14, wherein the metal wire is woven within the textile.

16. A method of manufacturing a woven textile comprising:
weaving at least one lighting filament with one or more weavable threads to form a textile with integrally woven lighting.

17. The method of claim 16, wherein the weaving comprises forming a textile ith integrally woven lighting in the form of a ribbon.

18. The method of claim 17, further comprises forming a bow from the ribbon.

19. The method of claim 16, wherein the weaving comprises forming a table runner from the textile with integrally woven lighting.

20. The method of claim 16, wherein the weaving comprises weaving a metal wire with the at least one lighting filament the one or more weavable threads to form the textile with integrally woven lighting and integrally woven metal wire.
